(19) United States
(12) Patent Application Publication
(10) Pub. No.: US 2026/0086195 A1
(43) Pub. Date: Mar. 26, 2026

(54) RADAR DEVICE

(71) Applicant: STMicroelectronics International N.V., Geneva (CH)

(72) Inventors: Samuel DUBOULOZ, Vetraz-Monthoux (FR); Fabien JAMMES, Brison St Innocent (FR); Augustin MANECY, AIX LES BAINS (FR)

(73) Assignee: STMicroelectronics International N.V., Geneva (CH)

(21) Appl. No.: 19/334,016

(22) Filed: Sep. 19, 2025

(30) Foreign Application Priority Data
Sep. 26, 2024 (FR) FR2410289

(51) Int. Cl. G01S 7/34; G01S 13/02; G01S 13/04

(52) U.S. Cl. CPC G01S 7/34; G01S 13/0209; G01S 13/04

(57) ABSTRACT

A transmit-receive circuit transmits radar waves and receives radar echoes consecutive to the transmission of the radar waves. A control circuit controls successive transmissions of radar waves with increasing transmit powers by the transmit-receive circuit and adjusts, after each reception of the radar echoes consecutive to each of the successive transmissions of radar waves by the transmit-receive circuit, a value of receive gain of the transmit-receive circuit as a function of a time period elapsed since the transmission. The effect is that a maximum amplitude of a response of the radar echoes received from the transmit-receive circuit is lower than a saturation value in receive mode of the transmit-receive circuit.

### PRIORITY CLAIM

This application claims the priority benefit of French Application for Patent No. FR2410289, filed on September 26, 2024, the content of which is hereby incorporated by reference in its entirety to the maximum extent allowable by law.

### TECHNICAL FIELD

The present disclosure generally concerns the field of radar devices.

### BACKGROUND

In the automotive sector, it is more and more frequent to equip every vehicle with a device for detecting the presence of children in the passenger compartment of the vehicle.

Such a device may use radar waves, for example of Impulse-Radio Ultra-Wideband (IR-UWB) type. The use of IR-UWB radar waves enables to obtain precise telemetry capabilities based on the measurement of the arrival time of radar echoes and their time variations.

The use of a radar device in a closed environment, such as for example the passenger compartment of a vehicle, generates a large number of radar echoes, with different levels of power, or amplitude, which depend in particular on the distances between the radar device and the obstacles having radar waves reflecting thereon, as well as on the materials and on the shapes of these obstacles.

The transmit power and the reception gain of the radar device may be adjusted according to the distance between the device and the detected target. However, in the case of a use in a closed environment, it is possible for the target not to be detected if, for example, it is masked (that is, the limited dynamic range of the receiver does not enable to cover too wide an amplitude spread between strong and weak echoes) by a significant obstacle generating strong radar echoes.

To solve this problem, it is possible to improve the detection sensitivity, or accuracy, of the radar device by increasing the accuracy of certain components of the radar device, such as for example the number of bits of the analog-to-digital converters of the radar device. However, this solution generates an increase in the power consumption of the radar device.

There exists a need to provide a radar device which does not have at least part of the disadvantages of known solutions.

There is a need to overcome all or part of the disadvantages of known radar devices

### SUMMARY

In an embodiment, a device comprises: a transmit-receive circuit configured to transmit radar waves and receive radar echoes consecutive to the transmission of the radar waves; a control circuit configured to control successive transmissions of radar waves with increasing powers of transmission by the transmit-receive circuit, and to adjust, after each reception of the radar echoes consecutive to each of the successive transmissions of radar waves by the transmit-receive circuit, a value of the receive gain of the transmit-receive circuit as a function of a time period elapsed since said transmission in such a way that a maximum amplitude of a response of the radar echoes received from the transmit-receive circuit is lower than a saturation value in receive mode of the transmit-receive circuit.

According to a specific embodiment, the control circuit is configured to adjust the value of the receive gain of the transmit-receive circuit in such a way that amplitudes of power peaks present in the response of the radar echoes consecutive to a last one of the successive radar wave transmissions are higher than a receive sensitivity of the transmit-receive circuit and lower than the saturation value in receive mode of the transmit-receive circuit.

According to a specific embodiment, the control circuit is configured to adjust the value of the receive gain of the transmit-receive circuit by lowering said value during at least one time interval during which at least one power peak is present in the response of the radar echoes.

According to a specific embodiment, the control circuit is configured to adjust the value of the receive gain of the transmit-receive circuit by parameterizing beginning and end times of said at least one time interval and time periods during which the receive gain changes value during said at least one time interval.

According to a specific embodiment, the control circuit is configured to control the transmit-receive circuit in such a way that the number of successive transmissions of radar waves is a function of a predetermined pulse response length and of intrinsic characteristics of the transmit-receive circuit, and/or to control the successive transmissions of radar waves by increasing, at each of said transmissions, the transmit power by a plurality of dB, that is, by at least 2 dB, until a maximum transmit power of the transmit-receive circuit is reached.

According to a specific embodiment, the control circuit is configured to set a transmit power of at least one first power amplifier of the transmit-receive circuit and/or to control low-noise switches activating or deactivating components providing receive gain of the transmit-receive circuit and/or to set a receive power of at least a second power amplifier of the transmit-receive circuit.

According to a specific embodiment, the transmit-receive circuit is configured to transmit radar waves and receive UWB-type radar echoes.

According to a specific embodiment, the control circuit comprises at least one processing unit configured to analyze the received radar echoes and determine the value of the receive gain of the transmit-receive circuit as a function of the time period elapsed since the transmission of the radar waves, and at least one real-time control unit comprising at least one input coupled to at least one output of the processing unit and configured to output control parameters for components of the transmit-receive circuit, enabling to obtain the value of the receive gain to be applied by the transmit-receive circuit as a function of the time period elapsed since the transmission of the radar waves.

According to a specific embodiment, the real-time control unit of the control circuit comprises at least one finite state machine.

There is also proposed a vehicle comprising at least one device such as previously described and configured to transmit radar waves into a passenger compartment of the vehicle.

According to a specific embodiment, the device is configured to detect a presence of at least one child in the passenger compartment of the vehicle.

There is also provided a radar detection method, comprising at least: transmitting radar waves by a transmit-receive circuit; receiving, by the transmit-receive circuit, radar echoes consecutive to the transmission of radar waves; adjusting a value of a receive gain of the transmit-receive circuit as a function of a time period elapsed since the transmission of the radar waves in such a way that a maximum amplitude of a response of the radar echoes received from the transmit-receive circuit is lower than a saturation value in receive mode of the transmit-receive circuit; and wherein transmitting, receiving, and adjusting are repeated by increasing, at each of the implementations of these steps, the power of transmission of the radar waves of the transmit-receive circuit.

According to a specific embodiment, the value of the receive gain of the transmit-receive circuit is adjusted in such a way that amplitudes of power peaks present in the response of the radar echoes consecutive to a last one of the implemented radar wave transmissions are lower than the saturation value in receive mode and higher than a receive detection threshold of the transmit-receive circuit.

According to a specific embodiment, the receive gain value of the transmit-receive circuit is adjusted by lowering said value during at least one time interval during which at least one power peak is present in the response of the radar echoes.

According to a specific embodiment, the value of the receive gain of the transmit-receive circuit is adjusted by parameterizing beginning and end times of said at least one time interval and time periods during which the receive gain changes value during said at least one time interval.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows an example of a radar device according to a specific embodiment;

FIG. 2 schematically shows an example of a vehicle in which the radar device is used;

FIG. 3 shows examples of signals of the radar device according to a specific embodiment.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, various elements (transmit-receive circuit, control circuit, processing unit, real-time control unit, etc.) of the radar device are not detailed. Further, the radar device may comprise other components or circuits not described herein, such as for example components and circuits used for the processing of the transmitted radar waves and of the received radar echoes, such as analog-to-digital converters used to convert radar echoes into digital signals. Those skilled in the art will be capable of manufacturing these elements in detail based on the functional description given herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as "front", "back", "top", "bottom", "left", "right", etc., or relative position qualifiers, such as "top", "bottom", "upper", "lower", etc., or orientation qualifiers, such as "horizontal", "vertical", etc., reference is made unless otherwise specified to the orientation of the drawings, in a normal position of use.

Unless specified otherwise, the expressions "about", "approximately", "substantially", and "in the order of" signify plus or minus 10%, preferably of plus or minus 5%.

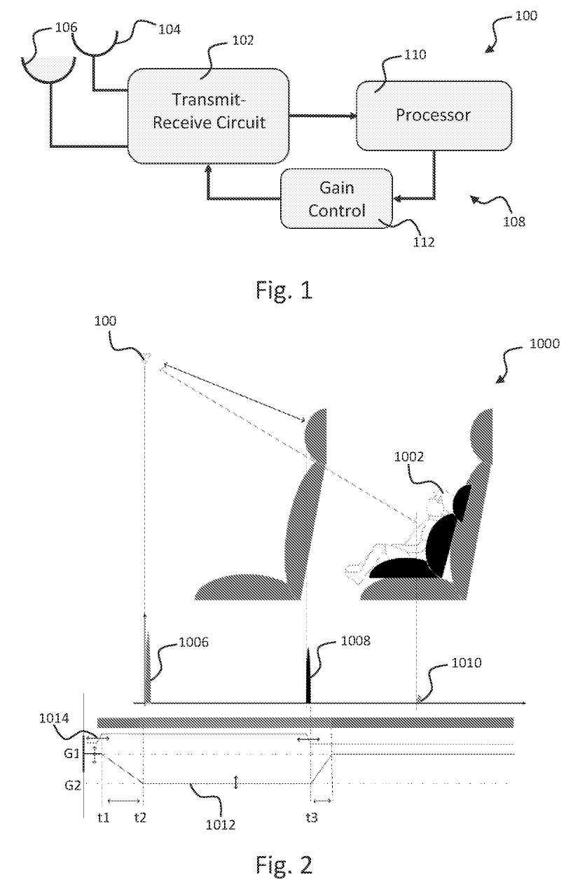

FIG. 1 schematically shows an example of a radar device 100 according to a specific embodiment.

Device 100 comprises at least one transmit-receive circuit 102 configured to transmit radar waves and to receive radar echoes consecutive to the transmission of these radar waves, that is, first corresponding to the direct path between transmit antenna 104 and receive antenna 106, and then to the echoes of these radar waves after reflection thereof, particularly on the target as well as on possible obstacles present in the path of the radar waves.

In the example of FIG. 1, transmit-receive circuit 102 corresponds to a single circuit coupled to at least two antennas 104, 106, one antenna used for the transmission of radar waves and the other antenna used for the reception of radar echoes. As a variant, it is possible for device 100 to comprise a single antenna coupled to transmit-receive circuit 102, and used both for the transmission of radar waves and the reception of radar echoes. According to another variant, it is possible for device 100 to comprise at least two antennas used for the transmission of radar waves and/or at least two antennas used for the reception of radar echoes, these different antennas being coupled to transmit-receive circuit 102.

Further, in the described example, the device comprises a single circuit 102 used for the transmission of radar waves and for the reception of radar echoes. As a variant, it is possible for the transmission of radar waves to be performed by a transmitter circuit, and for the reception of radar echoes to be performed by a receiver circuit separate from the transmitter circuit, these circuits forming together transmit-receive circuit 102.

According to an embodiment, transmit-receive circuit 102 may be configured to transmit radar waves and receive radar echoes of Ultra Wideband (UWB) type, and in particular of IR-UWB type. Radar waves, as well as radar echoes, are in the form of pulses or of sequences of wave pulses. As a variant, transmit-receive circuit 102 may be configured to transmit and receive radar waves of a type other than UWB.

Device 100 further comprises at least one gain control circuit 108 configured to control successive radar wave transmissions with increasing powers of transmission by transmit-receive circuit 102, and to adjust, after each reception of the radar echoes consecutive to each of the successive radar wave transmissions, a value of the receive gain of transmit-receive circuit 102 as a function of a time period elapsed since said transmission in such a way that a maximum amplitude of a response of the radar echoes received from transmit-receive circuit 102 is lower than a receive saturation value of transmit-receive circuit 102. The saturation of an amplifier circuit, in receive or transmit mode occurs when the requested output level is higher than the maximum level that the amplifier can provide. The output level being proportional to the product of the gain by the input level, the saturation thus occurs, in particular, when the input level is too high.

In the example of FIG. 1, control circuit 108 comprises at least one processing unit 110, processor or processing circuit, configured to analyze the received radar echoes and determine the value of the receive gain of transmit-receive circuit 102 to be applied as a function of the time period elapsed since the radar wave transmission so that the maximum amplitude of the response of the radar echoes received by transmit-receive circuit 102 remains lower than the receive saturation value of transmit-receive circuit 102. This processing unit 110 may, for example, comprise a program analyzing the data supplied by transmit-receive circuit 102 and which concern the received radar echoes, and outputting the values of the receive gain intended to be applied by transmit-receive circuit 102 as a function of time.

Further, in this example, control circuit 108 also comprises a real-time control unit 112 comprising an input coupled to an output of processing unit 110 and comprising an output coupled to transmit-receive circuit 102. Real-time control unit 112 is here configured to receive as an input the values of the receive gain intended to be applied by transmit-receive circuit 102 and to output control parameters of components of transmit-receive circuit 102 enabling to obtain these receive gain values to be applied by transmit-receive circuit 102 as a function of the time period elapsed since the radar wave transmission.

As a variant, processing unit 110 and real-time control unit 112 may be manufactured in the form of a single unit or of a single circuit.

According to an example of embodiment, real-time control unit 112 may comprise at least one finite state machine, or finite automaton, for example of "high-speed finite state machine" type, enabling to determine the values of the control parameters of the components of transmit-receive circuit 102 to be applied as a function of the desired receive gain values.

Transmit-receive circuit 102 may comprise various components dynamically controllable, or programmable, for example in real time, by means of which it is possible, on the one hand, to control in real time the power of transmission of radar waves by circuit 102, and on the other hand to control in real time the time-dependent gain of reception of radar echoes by circuit 102. Thus, for the control of the radar wave transmit power, transmit-receive circuit 102 may, in particular, comprise at least one first power amplifier used for the transmission of radar waves, and real-time control unit 112 may output control parameters setting the power delivered by this first power amplifier, for example via the activation or not of its various power stages. For the control of the receive gain of radar echoes, transmit-receive circuit 102 may in particular comprise low-noise switches and/or at least one second power amplifier used for the reception of radar echoes, and real-time control unit 112 may, at specific times of the reception, output control parameters switching the switches used to activate or deactivate certain components or blocks providing receive gain and/or adjusting the power delivered by the second power amplifier.

FIG. 2 schematically shows the use of device 100 in a vehicle 1000. In this example of embodiment, device 100 is intended to transmit radar waves into the passenger compartment of the vehicle in order to detect the presence of one or more people, in particular one or more children (a child designated by reference 1002 is shown in FIG. 2).

In FIG. 2, the radar waves transmitted by device 100 generate three types of radar echoes which are received by device 100. First high-power radar echoes 1006 received very shortly after the radar wave transmission by device 100 correspond to the direct paths generated by device 100 itself. Second high-power radar echoes 1008 correspond to echoes reflected by obstacles (vehicle seats present on the path of the radar waves, for example). Finally, third radar echoes 1010 of lower power than the first and second radar echoes 1006, 1008 correspond to those returned by the target intended to be detected. These various echoes form, in the response of the radar echoes received by device 100, power peaks having different amplitudes.

In such a case, if the receive gain of transmit-receive circuit 102 is left at a constant value during the reception of these different radar echoes, there exists a risk for the third radar echoes 1010 not to be detected because they are masked by the first and second radar echoes 1006, 1008. Indeed, the gain being adjusted to strong echoes, weak echoes are not sufficiently amplified and fall below the receiver sensitivity adjusted to strong echoes.

Control circuit 108 is intended to adjust the value of the receive gain of transmit-receive circuit 102 as a function of the time period elapsed since the radar wave transmission, so that a maximum amplitude of the response of the various received radar echoes remains lower than the saturation value of transmit-receive circuit 102, while maintaining a good reception sensitivity for weak radar echoes. In FIG. 2, reference 1012 designates an example of the receive gain applied by transmit-receive circuit 102, and reference 1014 designates a control signal applied by control circuit 108 to transmit-receive circuit 102 to obtain the desired receive gain. In this example, the receive gain is such that it changes, between times t₁ and t₂, from a first value G1, corresponding to a desired gain value during the reception of the radar echoes returned by the target intended to be detected, to a value G2, lower than G1 and corresponding to a desired gain value during the reception of the false radar echoes to be attenuated (radar echoes 1006, 1008 in this example), before the reception of the first radar echoes 1006, so that during the reception of the first and second radar echoes 1006, 1008, between times t₂ and t₃, the receive gain is equal to G2. For example, to obtain the gain values desired as a function of time, it is possible to parameterize the times from which the changes in receive gain value are made, the values of the gain levels, the durations of the ramps formed by the transition from a first to a second value of the receive gain, etc.

To determine the gain values to be applied in receive mode so that device 100 can correctly detect the desired target, for example a child in the passenger compartment of a car, control circuit 108 is configured to control successive radar wave transmissions with increasing transmit powers by transmit-receive circuit 102 and to adjust, after each reception of the radar echoes consecutive to each of the successive radar wave transmissions, the receive gain of transmit-receive circuit 102 as a function of a time period elapsed since said transmission in such a way that a maximum amplitude of a response of the radar echoes received from transmit-receive circuit 102 remains lower than a saturation value in receive mode of transmit-receive circuit 102. Further, the first transmit power applied by transmit-receive circuit 102 during a first radar wave transmission may be such that no power peak of the received radar echoes reaches the saturation value in receive mode of circuit 102.

In a specific configuration, control circuit 108 may be configured to adjust the value of the receive gain of transmit-receive circuit 102 in such a way that amplitudes of power peaks present in the response of the radar echoes consecutive to a last one of the successive radar wave transmissions are lower than the saturation level and higher than the detection threshold in order to dynamically adjust the sensitivity of the receiver to the power of the echoes of each time window. Further, control circuit 108 may be configured to adjust the value of the receive gain of transmit-receive circuit 102 by lowering said value during one or a plurality of time intervals during which one or a plurality of power peaks are present in the response of the received radar echoes.

As an alternative, other configurations of the control circuit 108, different from that above-indicated, are possible. For example, the amplitude of one or more power peaks, but not all power peaks, of the response obtained after the last transmission of radar waves may be greater than the reception sensitivity of the circuit 102.

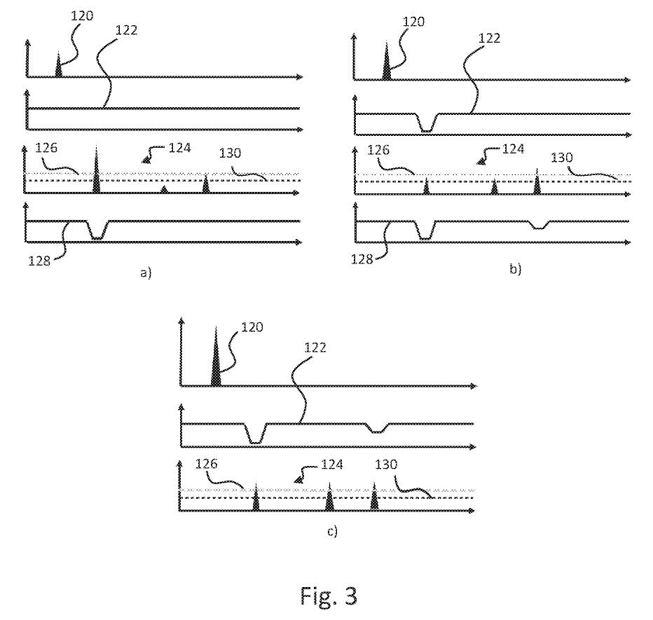

FIG. 3 schematically shows examples of signals of device 100 during the determination of the receive gain values to be applied by circuit 102.

At step a), radar waves 120 are transmitted by transmit-receive circuit 102 with a first power P1. Reference 122 designates the control signal applied by control circuit 108 to transmit-receive circuit 102 to obtain the desired receive gain. At this step a), this control signal is such that the gain is at a first value G1, corresponding to the desired receive gain value during the reception of the radar echoes intended to be returned by the target to be detected. Reference 124 designates the response of the radar echoes received by transmit-receive circuit 102, and reference 126 designates a reference amplitude level used to parameterize the values of the receive gain of circuit 102. In the shown example, the received first radar echoes form a first power peak having an amplitude greater than reference amplitude level 126, while the amplitudes of the power peaks of subsequent radar echoes are lower than this amplitude level 126. Reference 128 designates the control signal calculated by control circuit 108 and which will be applied to transmit-receive circuit 102 at the second radar wave transmission. This control signal is such that the receive gain of transmit-receive circuit 102 is decreased from value G1 to a value G2 lower than G1 during the reception of the first radar echoes. Finally, reference 130 designates a detection threshold illustrating the sensitivity of the reception chain used, that is, the energy value below which an echo cannot be detected.

At step b), the radar waves 120 are transmitted again by transmit-receive circuit 102 with a second power P2 higher than the first power P1. At this step b), the control signal 122 applied by control circuit 108 to transmit-receive circuit 102 to obtain the desired values of the receive gain corresponds to the control signal 128 previously calculated at the end of step a). Given the decrease in the value of the receive gain achieved during the time period for which the first radar echoes are received, the first power peak generated by the reception of the first radar echoes is strongly attenuated and is such that its amplitude is lower than reference amplitude level 126. Further, given the increase in the transmit power of radar waves 120 achieved between steps a) and b), the amplitudes of the power peaks of the subsequent radar echoes (second and third in this example) are higher than those obtained at step a). In particular, in the described example, the amplitude of the power peak of the received third radar echoes has become higher than reference amplitude level 126. The control signal calculated by control circuit 108 and which will be applied to transmit-receive circuit 102 at the third radar wave transmission is thus here such that the receive gain of transmit-receive circuit 102 is decreased on reception of the first radar echoes and, to a lesser extent, also on reception of the third radar echoes. Further, the amplitude of the power peak of the second echoes, which was previously lower than detection threshold 130, here becomes higher than this detection threshold 130.

At step c), the radar waves 120 are transmitted again by transmit-receive circuit 102 with a third power P3 higher than second power P2. At this step c), the control signal 122 applied by control circuit 108 to transmit-receive circuit 102 to obtain the desired receive gain values corresponds to the control signal 128 previously calculated at step b). Given the decreases in the value of the receive gain achieved during the time periods during which the first and third radar echoes are received, and given the increase in the transmit power used, the various power peaks consecutive to the reception of the different radar echoes are at levels substantially equal to one another.

Thus, due to the achieved adjustment of the values of the receive gain, the amplitudes of the various power peaks obtained in the response of the received radar echoes are substantially equal to one another, which enables to obtain a good sensitivity of detection of the searched target, its associated power peak not being masked by the other power peaks due to unwanted radar echoes. In particular, device 100 enables not to saturate the other circuits and components of device 100, in particular the analog-to-digital converters processing the received radar signals, and more particularly the amplification stages.

As an alternative, the reception gain adaptation performed by the control circuit 108 may be different from that performed in the above example. The adaptation of the reception gain value of the transmit-receive circuit 102 such that the peak power amplitudes present in the response 124 of the radar echoes 1006, 1008, 1010 following a last of the radar wave transmissions 120 implemented are lower than the reception saturation value and higher than a reception detection threshold of the transmission-reception circuit 102 corresponds to one of several possible configurations of the device 100. For example, it is possible that after the last radar wave transmission, the amplitude of at least one power peak, but not all power peaks, of the response is greater than the reception detection threshold of the circuit 102.

In the above-described example of embodiment, a first sequence of radar waves is transmitted with a power P1, followed by a new sequence of radar waves with power P2, and so on. The number of waves transmitted per sequence is determined primarily by the processing grain, or fineness, required to receive echoes for a given distance. The more distant the echoes to be received, the greater the number of radar waves in the transmitted sequence, the energies of each wave being accumulated. In the described example of embodiment, three or four successive transmissions, or iterations on the signal power, are implemented, but it is possible for a large number of radar echoes to be received for each sequence of transmitted waves. Further, given the time for establishing the gains due to the intrinsic characteristics of circuit 102, such as for example switching times, necessary rise times, etc., it is possible not to have as many configurations as radar echoes. The number of tested configurations, that is, the number of successive radar wave transmissions, may depend on the length of the impulse response sought and on the minimum size of a configurable time window sought, which is linked to the intrinsic characteristics of circuit 102, such as rise times, switching times, etc.

Further, control circuit 108 may control the successive radar wave transmissions by increasing, at each of said transmissions, the transmit power by a plurality of dB, for example 3 dB, or between 2 and 10 dB, or between 2 and 5 dB, or between 2 and 3 dB. This transmit power increase value may depend on the desired strategy and on the intrinsic properties of the receive chain used, such as for example the number of bits of an analog-to-digital converter of the receive chain. As a variant, other intervals for increasing the transmitted power are possible. For example, it is possible to decrease, during radar echo reception time periods, the receive gain by the same proportion as the transmit power is increased.

The last transmit power used at the end of the successive radar wave transmissions performed by circuit 102 may correspond to the maximum transmit power of circuit 102.

Radar device 100 performs successive transmissions of radar waves with an iterative increase of the transmit power used, starting with a low value to avoid the occurrence of the saturation of the response of the received radar echoes. By increasing the transmit power, new radar echoes appear. The gain can then be adjusted, that is, decreased, for echoes having too high a power captured by circuit 102, so that at the last radar wave transmission, for example carried out with the maximum transmit power of circuit 102, the applied gain values enable to avoid any saturation during the reception of the various radar echoes.

The parameterizing of the receive gain such as described above may be implemented for each detection performed by device 100, or just once on initialization of device 100.

Device 100 is configured to transmit radar waves and to evaluate the level of the radar echoes and provide feedback to control circuit 108 to dynamically adjust the receive parameters of the device to avoid strong radar echoes potentially capable of masking weaker radar echoes that may correspond to those of the target to be detected. Device 100 may form a radar device of enhanced sensitivity with a real-time adjustment control of transmit-receive circuit 102, which detects high-power echoes and avoids them by precisely controlling in real time the receive gain parameters of circuit 102. In the previously-described example, the transmit power, the delays, and the receive gain are controlled, but other parameters may be considered.

The provided device 100 enables, as compared with a conventional radar detection device, to improve the detection sensitivity without generating an increase in the power consumption.

Device 100 may be part of a microcontroller provided with a radar wave transceiver circuit, for example of UWB type.

As a variant of the previously-described example, device 100 may be used for any radar application other than that of presence detection in a passenger compartment of a vehicle, for example any UWB or non-UWB radar application, in the automotive field or not.

Many applications are likely to benefit from the advantages provided by device 100, and device 100 may be integrated according to various configurations.

As an example, device 100 may be integrated in a device intended for the automotive industry. The electrification of motor vehicles is causing a sharp increase in the number of electronic components present in vehicles. The device is, for example, intended to be incorporated into said vehicles. Further, driving assistance and driving automation are causing an increase in the number of electronic components in vehicles. The device comprises, for example, elements enabling to protect the device against electrical hazards.

As an example, device 100 may be intended for the industry. In particular, the device is, for example, used for the development of green energies or for the electrification of facilities, for example for charging stations or for solar energy collection. The device may also be used in the field of the Internet of Things or in the field of smart homes. The device is, for example, intended to be implemented in circuits supplying electrical power to equipment.

As an example, device 100 can be integrated in a device intended to be used in personal electronics, for example with the aim of increasing a volume of information exchanged by radio frequency communication, in 5G communication systems, or more generally in any connected device. The device is, for example, a cell phone, or smartphone, or forms part of an Internet of Things network. The device is, for example, connected by 5G, WiFi or broadband communication. The device comprises, for example, high-speed interfaces, for example with an advanced filtering and ESD protection.

As an example, device 100 can be integrated in communications equipment, or in computers and peripherals. The device is, for example, used in 5G infrastructures and dedicated data centers. The device can also be used in satellites comprising, for example, integrated passive devices for radio frequency applications.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A device, comprising:
a transmit-receive circuit configured to transmit radar waves and receive radar echoes responsive to the transmitted the radar waves; and
a control circuit configured to control successive transmissions by the transmit-receive circuit of radar waves with increasing powers of transmission and to adjust, after each reception by the transmit-receive circuit of the radar echoes, a value of a receive gain of the transmit-receive circuit as a function of a time period elapsed since radar wave transmission in such a way that a maximum amplitude of a response of the radar echoes received from the transmit-receive circuit is lower than a saturation value in receive mode of the transmit-receive circuit.

2. The device according to claim 1, wherein the control circuit is configured to adjust the value of the receive gain of the transmit-receive circuit so that amplitudes of power peaks present in the response of the radar echoes consecutive to a last one of the successive transmissions of radar waves are higher than a receive sensitivity of the transmit-receive circuit and lower than the saturation value in receive mode of the transmit-receive circuit.

3. The device according to claim 1, wherein the control circuit is configured to adjust the value of the receive gain of the transmit-receive circuit by lowering said value of the receive gain during at least one time interval during which at least one power peak is present in the response of the radar echoes.

4. The device according to claim 3, wherein the control circuit is configured to adjust the value of the receive gain of the transmit-receive circuit by parameterizing beginning and end times of said at least one time interval and time periods during which the receive gain changes value during said at least one time interval.

5. The device according to claim 1, wherein the control circuit is configured to control the transmit-receive circuit so that a number of successive radar wave transmissions is a function of a predetermined pulse response length and of intrinsic characteristics of the transmit-receive circuit.

6. The device according to claim 1, wherein the control circuit is configured to control the successive transmissions of radar waves by increasing, at each of said transmissions, the transmit power by at least 2 dB until a maximum transmit power of the transmit-receive circuit is reached.

7. The device according to claim 1, wherein the control circuit is configured to set a transmit power of at least one first power amplifier of the transmit-receive circuit.

8. The device according to claim 1, wherein the control circuit is configured to control low-noise switches activating or deactivating components providing receive gain of the transmit-receive circuit.

9. The device according to claim 1, wherein the control circuit is configured to set a receive power of at least one second power amplifier of the transmit-receive circuit.

10. The device according to claim 1, wherein the transmit-receive circuit is configured to transmit radar waves and receive radar echoes of UWB type.

11. The device according to claim 1, wherein the control circuit comprises:
at least one processing unit configured to analyze the received radar echoes and determine the value of the receive gain of the transmit-receive circuit as a function of the time period elapsed since the transmission of the radar waves; and
at least one real-time control unit comprising at least one input coupled to at least one output of the processing unit and configured to output control parameters of components of the transmit-receive circuit enabling to obtain the value of the receive gain to be applied by the transmit-receive circuit as a function of the time period elapsed since the transmission of the radar waves.

12. The device according to claim 11, wherein the real-time control unit of the control circuit comprises at least one finite state machine.

13. A vehicle, comprising the device according to claim 1, wherein the transmit radar waves are directed into a passenger compartment of the vehicle.

14. The vehicle according to claim 13, wherein the device is configured to detect a presence of at least one child in the passenger compartment of the vehicle.

15. A radar detection method, comprising:
transmitting radar waves by a transmit-receive circuit;
receiving, by the transmit-receive circuit, radar echoes consecutive to the transmission of radar waves;
adjusting a value of a receive gain of the transmit-receive circuit as a function of a time period elapsed since transmission of the radar waves so that a maximum amplitude of a response of the radar echoes received from the transmit-receive circuit is lower than a saturation value in receive mode of the transmit-receive circuit; and
wherein transmitting, receiving, and adjusting are repeated by increasing, at each repeat, the power of transmission of the radar waves of the transmit-receive circuit.

16. The method according to claim 15, wherein the value of the receive gain of the transmit-receive circuit is adjusted so that amplitudes of power peaks present in the response of the radar echoes consecutive to a last one of the implemented radar wave transmissions are lower than the saturation value in receive mode and higher than a receive detection threshold of the transmit-receive circuit.

17. The method according to claim 15, wherein the value of the receive gain of the transmit-receive circuit is adjusted by lowering said value during at least one time interval during which at least one power peak is present in the response of the radar echoes.

18. The method according to claim 17, wherein the value of the receive gain of the transmit-receive circuit is adjusted by parameterizing beginning and end times of said at least one time interval and time periods during which the receive gain changes value during said at least one time interval.
